(19) United States
(12) Patent Application Publication
(10) Pub. No.: US 2014/0136705 A1
(43) Pub. Date: May 15, 2014

(54) Managing Effective Bytes Based on Radio Frequency Conditions

(71) Applicant: NOKIA SIEMENS NETWORKS OY, Espoo (FI)

(72) Inventors: John M. HARRIS, Glenview, IL (US); Gerald GÖRMER, Wandlitz (DE); Gerald GUTOWSKI, Glenview, IL (US)

(73) Assignee: Nokia Siemens Networks Oy, Espoo (FI)

(21) Appl. No.: 13/674,229

(22) Filed: Nov. 12, 2012

(51) Int. Cl. G06F 15/173

(52) U.S. Cl. 709/226

(57) ABSTRACT

A method includes requesting by a user equipment for data from an application provider through a wireless network; communicating by the application provider through the wireless network an effective rate policy for the data to the user equipment, the effective rate policy being applicable upon satisfaction by the user equipment of conditions communicated with the effective rate policy; and sending the data at the effective rate policy to the user equipment when the conditions are met by the user equipment. A related method includes receiving by a user equipment an effective rate policy for data from an application provider through a wireless network, the effective rate policy being applicable upon satisfaction by the user equipment of conditions communicated with the effective rate policy; satisfying the conditions by the user equipment; and receiving the data at the effective rate policy by the user equipment.

### TECHNICAL FIELD

This invention relates generally to wireless networks and to user equipment served by wireless networks, and, more specifically, relates to the provision of incentives to users to modify the timing and location of their acquisition of data through the wireless network based on network conditions.

### BACKGROUND

This section is intended to provide a background or context to the invention disclosed below. The description herein may include concepts that could be pursued, but are not necessarily ones that have been previously conceived, implemented, or described. Therefore, unless otherwise explicitly indicated herein, what is described in this section is not prior art to the description in this application, and is not admitted to be prior art by inclusion in this section. Abbreviations that may be found in the specification and/or the drawing figures are defined below at the end of the specification, but prior to the claims.

At the present time, the functionality of applications available to users in a wireless network and conditions on the network itself are to a large extent separate and disjoint. A number of opportunities exist for significantly improving efficiencies in the wireless network by eliminating the separation. However, there is a need for application developers to build ways into applications under development to use network resources more efficiently than is done at present.

One specific area in which efficiencies could be improved is that of prefetching or prefilling. These refer to the acquisition of data over a wireless network for reading or viewing subsequent to what the user may currently be viewing or reading. This applies to a range of applications available to user equipment on a wireless network, including video, social network updates, newsreaders, software updates, and many others, and refers to the automatic transmission and downloading of data to user equipment. Unfortunately, much of the data “prefetched” in this manner is never viewed or otherwise used, as the user is often likely to move on to another task without doing so. Thus, a great deal of transmission on a wireless network is ultimately wasted. This unused traffic on a wireless network prevents its resources from being used more efficiently.

A number of proposals for improvement in this area have focused on the wireless network injecting itself into the middle of the application and micromanaging or dictating what application adaptation should occur; that is, for example, the network would allow or disallow video prefilling based on a variety of network criteria.

However, the idea of having the network explicitly perform content re-optimization raises a number of other issues. For example, for a number of different applications, such as Apple Live Streaming/Netflix, Microsoft Smooth Stream, and certain social networking applications, this sort of control is not possible within the network, because the application must initiate a request for the URL for the next section of video before the network can play a role in the delivery of that section of video. If the application does not request the URLs for the video which are beyond just-in-time, then that video will not be downloaded.

Additionally, it may be prohibitively expensive to have the network explicitly in the middle of the application path to achieve these changes, for example, because of the processing requirements of recompression within the network. And, as mentioned above, when prefetching, there is a chance that the content being prefetched will never be viewed or read by the user. This will happen, for example, when the user loses interest in a story or video, and exits without reading or viewing more. Therefore, there is a need for a mechanism which will enable the balancing of the amount of prefetching with the amount of wireless resources available or being consumed.

For example, if the wireless network becomes more and more loaded, it is appropriate to stop a larger and larger fraction of prefetching, which has a lower likelihood of being consumed by the user, while continuing to allow a smaller and smaller fraction of prefetching, which has the highest likelihood of being consumed by the user. This incremental control of prefetching, in a way which exploits the application developers' deeper knowledge of the likelihood that the user will actually consume the content, will maximize the overall quality of the experience.

As a further example, if a user has a Facebook application, but does not often enter the Facebook application to read the latest threads, then that user will be unlikely to consume Facebook updates which have been prefetched. Therefore, unless the system is very unloaded (not busy), this user should not be prefetching Facebook updates. In contrast, if there is another user who frequently opens the Facebook application to read his or her friends' updates, then the application may persist with prefetching the updates, even if the system is relatively more loaded.

In all of this, the application has the deepest knowledge of such likelihoods, and this knowledge should be exploited in order to reach the most effective solution. New applications are constantly being developed, and there are already thousands of different applications and multiple UE operating systems, all of which makes it difficult for a network-based optimization to optimize every possible application. In short, application developers are in the best position to provide a solution to this problem.

As a consequence, the present invention seeks to provide a mechanism to motivate application developers to include the right adaptations in new applications.

At the present time, application developers are very motivated to provide the best possible end-user experience, to the widest range of consumers, while avoiding disproportionate use of resources. For example, application developers are interested in earning high ratings within application stores to drive additional downloads of their application, and would like to increase the number of users, including those with less money or smaller budgets (smaller gigabyte per month buckets, where a bucket measures the amount of data a user may access each month), who use and benefit from their applications, thereby driving greater penetration of their applications and potentially enabling money, which would have been spent on transport, to be spent on higher quality applications.

For example, if there are two applications which provide the same service, but the first one depletes the user's gigabyte per month bucket much more quickly than with the second application, then the first application will have a significant advantage to application developers, higher ratings and more downloads, and thus higher revenue from application sales and/or advertising.

Accordingly, the application, in general, has the deepest knowledge of the likelihood that prefetched content will be consumed, and, therefore, the application is in the best position to take the input and the format proposed by the present invention and to then use it to make it judicious decisions about the use of the user's resources to maximize the QoE (Quality-of-Experience) in the light of the user's resources (size of user's monthly bucket). The present invention provides a way in which this might be accomplished.

### SUMMARY

This section contains examples of possible implementations and is not meant to be limiting.

In certain exemplary embodiments, the present invention provides a mechanism for communicating “an effective rate policy” down to the subscriber operation system or application active on a UE (user equipment). This effective rate policy, is an indication that, for example, for each byte downloaded during an upcoming time interval, only 0.5 bytes will be deducted from the users monthly allocation, also known as a data bucket or, simply, bucket. The applicability of an effective rate policy, essentially a discount, may be governed by any of a number of factors. For example, the effective rate policy may be set based on loading or signal strength. In response to the rate being lower, the application/UE may respond by performing greater amounts of prefetching or prefilling. The user may even have the option to transport the UE into areas where the effective rate policy is smaller than it may be in the user's current location. The effective rate policy may also be indicated to the user to be in force in particular locations, for a particular number of bytes, a certain time interval, and other options. This indication may be conveyed down to the UE through a variety of standardized and proprietary/operator customized mechanisms.

An exemplary and non-limiting purpose of the present invention is to control prefetching or prefilling through economic means by providing a discount or incentive for the user to prefetch at a specified time or location where loading or signal strength in the wireless network might be more favorable than at the user's location at a given time, with the overall goal being to use the resources of the wireless network more efficiently.

In an exemplary embodiment, a method is disclosed for a wireless network. The method includes receiving a request from a user equipment for data from an application provider through a wireless network; communicating by the application provider through the wireless network an effective rate policy for the data to the user equipment, the effective rate policy being applicable upon satisfaction by the user equipment of conditions communicated with the effective rate policy; and sending the data at the effective rate policy to the user equipment when the conditions are met by the user equipment.

In another exemplary embodiment, a computer program product is disclosed including a non-transitory computer-readable storage medium bearing computer program code embodied therein for use with a computer, the computer program code comprising: code for receiving a request from a user equipment for data from an application provider through a wireless network; code for communicating by the application provider through the wireless network an effective rate policy for the data to the user equipment, the effective rate policy being applicable upon satisfaction by the user equipment of conditions communicated with the effective rate policy; and code for sending the data at the effective rate policy to the user equipment when the conditions are met by the user equipment.

In a further exemplary embodiment, an apparatus includes: means for receiving a request from a user equipment for data from an application provider through a wireless network; means for communicating by the application provider through the wireless network an effective rate policy for the data to the user equipment, the effective rate policy being applicable upon satisfaction by the user equipment of conditions communicated with the effective rate policy; and means for sending the data at the effective rate policy to the user equipment when the conditions are met by the user equipment.

In an additional exemplary embodiment, an apparatus is disclosed that includes one or more processors and one or more memories including computer program code. The one or more memories and the computer program code are configured, with the one or more processors, to cause the apparatus to perform: receiving a request from a user equipment for data from an application provider through a wireless network; communicating by the application provider through the wireless network an effective rate policy for the data to the user equipment, the effective rate policy being applicable upon satisfaction by the user equipment of conditions communicated with the effective rate policy; and sending the data at the effective rate policy to the user equipment when the conditions are met by the user equipment.

In still another exemplary embodiment, a method is disclosed for a user equipment. The method includes requesting data from an application provider through a wireless network; receiving an effective rate policy for the data from the application provider through the wireless network, the effective rate policy being applicable upon satisfaction of conditions communicated with the effective rate policy; satisfying the conditions; and receiving the data at the effective rate policy.

In yet another exemplary embodiment, a computer program product is disclosed including a computer-readable storage medium bearing computer program code embodied therein for use with a computer, the computer program code comprising: code for requesting data from an application provider through a wireless network; code for receiving an effective rate policy for the data from the application provider through the wireless network, the effective rate policy being applicable upon satisfaction of conditions communicated with the effective rate policy; code for satisfying the conditions; and code for receiving the data at the effective rate policy.

In a further exemplary embodiment, an apparatus includes: means for requesting data from an application provider through a wireless network; means for receiving an effective rate policy for the data from the application provider through the wireless network, the effective rate policy being applicable upon satisfaction of conditions communicated with the effective rate policy; means for satisfying the conditions; and means for receiving the data at the effective rate policy.

In an additional exemplary embodiment, an apparatus is disclosed that includes one or more processors and one or more memories including computer program code. The one or more memories and the computer program code are configured, with the one or more processors, to cause the apparatus to perform: requesting data from an application provider through a wireless network; receiving an effective rate policy for the data from the application provider through the wireless network, the effective rate policy being applicable upon satisfaction of conditions communicated with the effective rate policy; satisfying the conditions; and receiving the data at the effective rate policy.

### BRIEF DESCRIPTION OF THE DRAWINGS

In the attached Drawing Figures:

FIG. 1 illustrates a block diagram of an exemplary system in which the present invention may be used;

FIG. 2 is a block diagram of a flowchart of the method of the present invention for a wireless network; and

FIG. 3 is a block diagram of a flowchart of the method of the present invention for a user equipment.

### DETAILED DESCRIPTION OF THE DRAWINGS

Briefly, as discussed above, the goal of the present invention is to provide a mechanism for using the resources of the wireless network more efficiently by controlling prefetching through economic means by providing incentives in the form of discounts or reductions to encourage users to prefetch at a specified time or location where loading or signal strength in the wireless network might be more favorable than at the user's location at a given time.

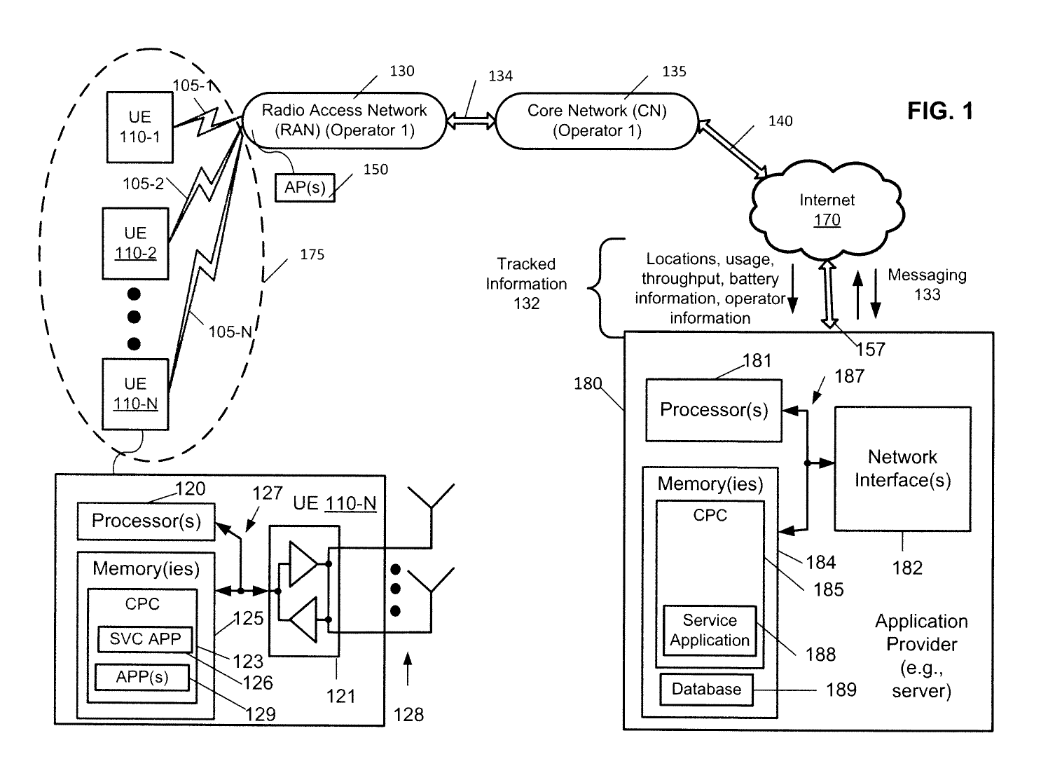

Turning to FIG. 1, this figure illustrates a block diagram of an exemplary system in which the instant invention may be used. In FIG. 1, N UEs 110-1 through 110-N are in wireless communication via corresponding wireless links 105 with one or more access points (APs) 150 that are part of a radio access network (RAN) 130. The APs 150 may be eNBs (evolved Node Bs, e.g., base stations for LTE, long term evolution, networks). The UEs 110 are in the geographical region 175. A block diagram of a UE 110-N is shown in FIG. 1, and it is assumed other UEs are similar. The UE 110-N includes one or more processors 120, one or more memories 125, and one or more transceivers 121, interconnected through one or more buses 127. The term “buses” should be construed broadly, to cover, e.g., wired, wireless, optical, and other communication systems. The one or more transceivers 121 are coupled to one or more antennas 128. The one or more memories 125 include computer program code (CPC) 123, comprising in this example a service application (SVC APP) 126, and one or more additional applications (APP(s)) 129. The one or more memories 125 and the computer program code 123 are configured, with the one or more processors 120, to cause the apparatus to perform the operations described herein.

An operator network includes the RAN 130 and also the core network (CN) 135, which are interconnected through link 134. The CN 135 is coupled to the Internet 170 via the link 140.

The application provider 180 includes one or more processors 181, one or more memories 184, and one or more network interfaces 182, interconnected through one or more buses 187. The term “buses” should be construed broadly, to cover, e.g., wired, wireless, optical, and other communication systems. The one or more network interfaces 180 can communicate via the link 157 with the Internet 170 or other networks. The one or more memories 184 include computer program code (CPC) 185, comprising in this example a service application 188. A database 189 is stored in the one or more memories 184. The one or more memories 184 and the computer program code 185 are configured, with the one or more processors 181, to cause the apparatus to perform the operations described herein.

The computer readable memories 125 and 184 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125 and 184 may implement a non-transitory computer readable storage medium, as part of a program product, and may be used to contain code for performing operations. The processors 120 and 181 may be of any type suitable to the local technical environment, and may include one or more of general purpose computers, special purpose computers, microprocessors, digital signal processors (DSPs), integrated circuits and/or programmable logic, and processors based on a multi-core processor architecture, as non-limiting examples.

In general, the various embodiments of the UE 110 may include, but are not limited to, smart phones, cellular mobile devices, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

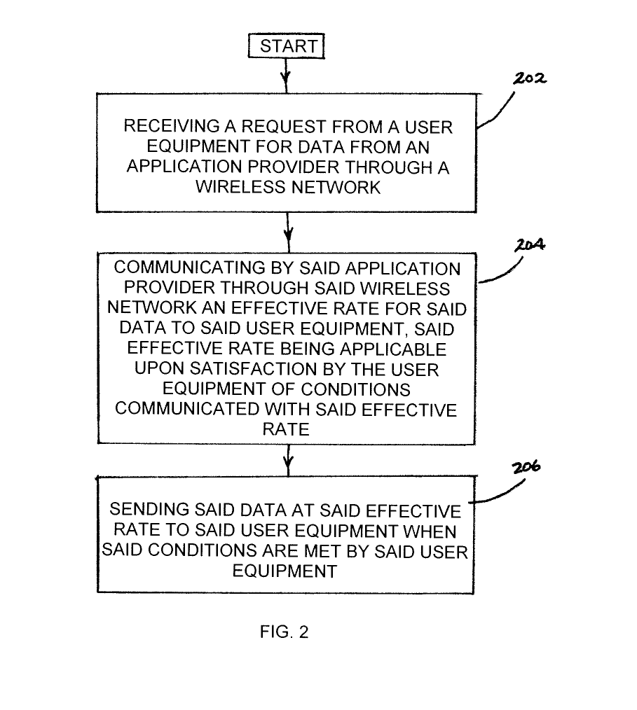

Turning to FIG. 2, a block diagram is shown of a flowchart of the method of the present invention for a wireless network. The flowchart may be a method performed by, for example, the application provider 180, may be a sequence of operations performed by computer program code as executed by the one or more processors 181, or may be a sequence of operations performed by hardware such as a logic circuit or integrated circuit.

In block 202, the wireless network receives a request from a user equipment for data from an application provider through a wireless network. In block 204, the application provider communicates an effective rate policy for the data to the user equipment through the wireless network. The effective rate policy is applicable upon satisfaction by the user equipment of conditions communicated with the effective rate policy. In block 206, the data is sent at the effective rate policy to the user equipment when the stated conditions are met by the user equipment.

The effective rate policy may be an effective data bucket deduction amount per byte of data sent to the UE, such that fewer bytes are deducted from the users data bucket if he or she meets the conditions communicated with the effective rate policy. The effective rate policy may alternatively be an effective usage volume bucket deduction amount per volume of usage of the data. The wireless network generates an effective rate policy smaller than a rate normally in effect in at least one of the following conditions: loading in a cell in which the user equipment is located is smaller than a predetermined threshold; the signal strength of the user equipment is larger than a predetermined threshold; and the number of physical resource blocks per byte transferred is smaller than a predetermined threshold.

The effective rate policy may have its applicability defined by a start time, an end time, and a duration. It may alternatively be applicable to a particular volume of data subsequent to the communication thereof. Alternatively, the effective rate policy may be applicable to a specific geographic location, geographic region, or service area.

The communication of an effective rate policy may also be accompanied by an indication of a second effective rate policy applicable to a second geographic location, second geographic region, or second service area, under a second signal strength or in a second time interval. Alternatively, the communication of an effective rate policy may be accompanied by an indication of a reduction applicable when a total volume of data transferred is greater than some threshold amount, and an indication of nonapplicability when the user equipment has depleted a monthly data bucket.

The effective rate policy may be managed through one or more of the following three effective rate policy components: a “per cell”, or “per geographic location”, effective rate policy component; a “per time zone” effective rate policy component; and a “per user equipment”, or “per physical resource block per information bit”, effective rate policy component. At least two of the three effective rate policy components may be combined in order to yield the effective rate policy for the user equipment.

The effective rate policy may be decreased by the network in at least one of the following conditions: a cell where the user equipment is located is less loaded than other cells; the user equipment has better signal strength than in other cells; the user equipment generates a lower level of interference than in other cells; the user equipment is being used to test a cell system; and the user equipment is being used to relay network traffic filling in coverage holes.

The effective rate policy may correspond to at least one of: free minutes; free data usage; higher bandwidth; free access to premium services; preferred access to new, upcoming services, features, or devices; credits which can be redeemed for goods or services.

The application provider providing an effective rate policy may be an advice-of-charging (AoC) system with a facilitation message.

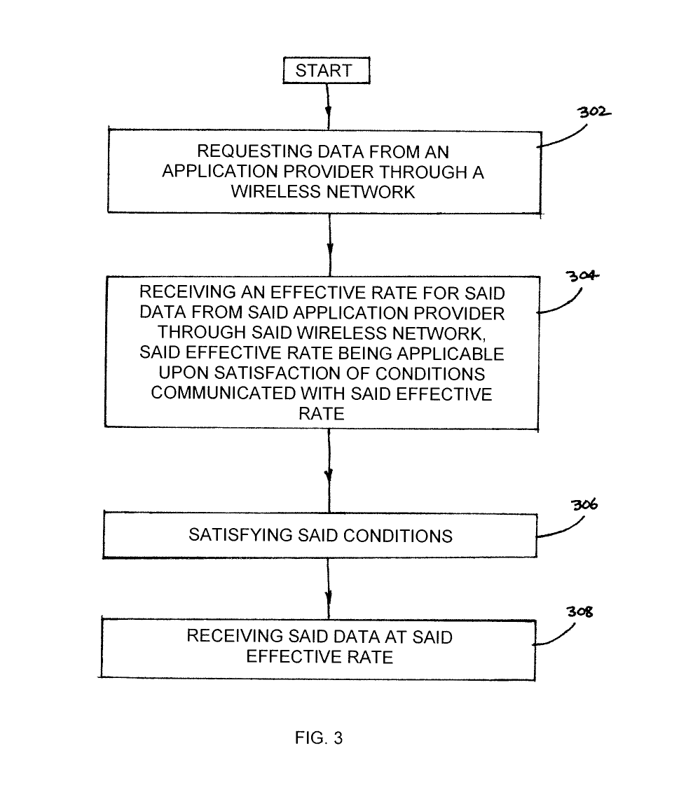

Turning to FIG. 3, a block diagram is shown of a flowchart of the method of the present invention for a user equipment. The flowchart may be a method performed by, for example, the UE 110, may be a sequence of operations performed by computer program code as executed by the one or more processors 120, or may be a sequence of operations performed by hardware such as a logic circuit or integrated circuit.

In block 302, the UE requests data from an application provider through a wireless network. In block 304, the UE receives an effective rate policy for the data from the application provider through the wireless network. The effective rate policy is applicable upon satisfaction by the user equipment of conditions communicated with the effective rate policy. In block 306, the UE satisfies the stated conditions. In block 308, the UE receives the data at the effective rate policy.

The effective rate policy may be an effective data bucket deduction amount per byte of data received by the UE, such that fewer bytes are deducted from the users data bucket if he or she meets the conditions communicated with the effective rate policy. The effective rate policy may alternatively be an effective usage volume bucket deduction amount per volume of usage of the data. When the effective rate policy is smaller than a rate normally in effect, a larger amount of data than that requested may be transferred.

The effective rate policy may be is specified to be smaller than a rate in effect at a given geographic location of the user equipment if the user equipment is moved to a different geographic location. When the effective rate policy is smaller than a rate normally in effect at a given geographic location, the UE may receive a larger amount of data than was requested.

When the effective rate policy is smaller than a predetermined threshold, the UE may receive notification that certain applications, such as Netflix, providing large amounts of data are more appropriate for use.

The effective rate policy may be used by the user equipment to track the number of bytes deducted from a monthly bucket by multiplying the actual number of bytes transferred by the deduction amount in force at the time of the volume transfer to obtain the number of bytes to be deducted. The effective rate policy, at different geographic locations, may be combined with the anticipated geographic locations of the user at future times, in order to predict the number of bytes deducted from a monthly bucket corresponding to a media selection by multiplying the actual number of bytes transferred by the deduction amount in force at the corresponding times and locations of the volume transfer to obtain the number of bytes to be deducted.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memory 125, 184 or other device) that may be any media or means that can contain or store the instructions for use by or in connection with an instruction execution system, apparatus, or device, such as a computer. As such, the present invention includes a computer program product comprising a computer-readable storage medium bearing computer program code embodied therein for use with a computer, the computer program code comprising code for performing any of the methods and variations thereof as previously described. Further, the present invention also includes an apparatus which comprises one or more processors, and one or more memories including computer program code, wherein the one or more memories and the computer program code are configured, with the one or more processors, to cause the apparatus to perform any of the methods and variations thereof as previously described.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

The following abbreviations that may be found in the specification and/or the drawing figures are defined as follows:

| | |
|---|---|
| AoC | Advice-of-Charging |
| AP | Access Point |
| APP | Application |
| CN | Core Network |
| CPC | Computer Program Code |
| DSP | Digital Signal Processor |
| eNB or eNode B | evolved Node B (LTE base station) |
| LTE | Long Term Evolution |
| PDA | Personal Digital Assistant |
| QoE | Quality-of-Experience |
| RAN | Radio Access Network |
| SVC | Service |
| UE | User Equipment |
| URL | Universal (or Uniform) Resource Locator |

What is claimed is:

1. A method comprising:
receiving a request from a user equipment for data from an application provider through a wireless network;
communicating by said application provider through said wireless network an effective rate policy for said data to said user equipment, said effective rate policy being applicable upon satisfaction by the user equipment of conditions communicated with said effective rate policy; and
sending said data at said effective rate policy to said user equipment when said conditions are met by said user equipment.

2. The method as claimed in claim 1, wherein said effective rate policy is an effective data bucket deduction amount per byte of said data.

3. The method as claimed in claim 1, wherein said effective rate policy is an effective usage volume bucket deduction amount per volume of usage of said data.

4. The method as claimed in claim 1, wherein said wireless network generates an effective rate policy smaller than a rate normally in effect in at least one of the following conditions:
loading in a cell wherein said user equipment is located is smaller than a predetermined threshold;
the signal strength of the user equipment is larger than a predetermined threshold; and
the number of physical resource blocks per byte transferred is smaller than a predetermined threshold.

5. The method as claimed in claim 1, wherein said effective rate policy has at least one of:
a start time, an end time, and a duration;
an indication of applicability to a particular subsequent volume of data;
an indication of applicability to a specific geographic location, geographic region, or service area;
an indication of a second effective rate policy applicable to a second geographic location, second geographic region, or second service area, under a second signal strength or in a second time interval;
an indication of a reduction applicable when a total volume of data transferred is greater than some threshold amount; and
an indication of nonapplicability when said user equipment has depleted a monthly data bucket therefor.

6. The method as claimed in claim 1, wherein the effective rate policy is managed through one or more of the following three effective rate policy components: a “per cell”, or “per geographic location”, effective rate policy component; a “per time zone” effective rate policy component; and a “per user equipment”, or “per physical resource block per information bit”, effective rate policy component.

7. The method as claimed in claim 6, wherein at least two of the three effective rate policy components are combined in order to yield the effective rate policy for said user equipment.

8. The method as claimed in claim 1, wherein the effective rate policy is decreased by the network in at least one of the following conditions:
a cell where the user equipment is located is less loaded than other cells;
the user equipment has better signal strength than in other cells;
the user equipment generates a lower level of interference than in other cells;
the user equipment is being used to test a cell system; and
the user equipment is being used to relay network traffic filling in coverage holes.

9. The method as claimed in claim 1, wherein effective rate policy corresponds to at least one of: free minutes; free data usage; higher bandwidth; free access to premium services; preferred access to new, upcoming services, features, or devices; credits which can be redeemed for goods or services.

10. An apparatus comprising:
one or more processors; and
one or more memories including computer program code;
the one or more memories and the computer program code configured, with the one or more processors, to cause the apparatus to perform:
receiving a request from a user equipment for data from an application provider through a wireless network;
communicating by said application provider through said wireless network an effective rate policy for said data to said user equipment, said effective rate policy being applicable upon satisfaction by the user equipment of conditions communicated with said effective rate policy; and
sending said data at said effective rate policy to said user equipment when said conditions are met by said user equipment.

11. A computer program product comprising a computer-readable storage medium bearing computer program code embodied therein for use with a computer, the computer program code comprising:
code for receiving a request from a user equipment for data from an application provider through a wireless network;
code for communicating by said application provider through said wireless network an effective rate policy for said data to said user equipment, said effective rate policy being applicable upon satisfaction by the user equipment of conditions communicated with said effective rate policy; and
code for sending said data at said effective rate policy to said user equipment when said conditions are met by said user equipment.

12. A method comprising:
requesting data from an application provider through a wireless network;
receiving an effective rate policy for said data from said application provider through said wireless network, said effective rate policy being applicable upon satisfaction of conditions communicated with said effective rate policy;
satisfying said conditions; and
receiving said data at said effective rate policy.

13. The method as claimed in claim 12, wherein said effective rate policy is an effective data bucket deduction amount per byte of said data.

14. The method as claimed in claim 12, wherein said effective rate policy is an effective usage volume bucket deduction amount per volume of usage of said data.

15. The method as claimed in claim 12, wherein, when said effective rate policy is smaller than a rate normally in effect, a larger amount of data than that requested may be transferred.

16. The method as claimed in claim 12, wherein said effective rate policy is specified to be smaller than a rate in effect at a given geographic location of said user equipment if said user equipment is moved to a different geographic location.

17. The method as claimed in claim 12, wherein, when said effective rate policy is smaller than a rate normally in effect at a given geographic location, the user equipment receives a larger amount of data than was requested.

18. The method as claimed in claim 12, wherein, when said effective rate policy is smaller than a predetermined threshold, the user equipment receives notification that certain applications providing large amounts of data are more appropriate for use.

19. The method as claimed in claim 12, wherein the effective rate policy is used by said user equipment to track the number of bytes deducted from a monthly bucket by multiplying the actual number of bytes transferred by the deduction amount in force at the time of the volume transfer to obtain the number of bytes to be deducted.

20. The method as claimed in claim 12, wherein the effective rate policy, at different geographic locations, is combined with the anticipated geographic locations of the user at future times, in order to predict the number of bytes deducted from a monthly bucket corresponding to a media selection by multiplying the actual number of bytes transferred by the deduction amount in force at the corresponding times and locations of the volume transfer to obtain the number of bytes to be deducted.

21. An apparatus comprising:
one or more processors; and
one or more memories including computer program code;
the one or more memories and the computer program code configured, with the one or more processors, to cause the apparatus to perform:
requesting data from an application provider through a wireless network;
receiving an effective rate policy for said data from said application provider through said wireless network, said effective rate policy being applicable upon satisfaction of conditions communicated with said effective rate policy;
satisfying said conditions; and
receiving said data at said effective rate policy.

22. A computer program product comprising a computer-readable storage medium bearing computer program code embodied therein for use with a computer, the computer program code comprising:
code for requesting data from an application provider through a wireless network;
code for receiving an effective rate policy for said data from said application provider through said wireless network, said effective rate policy being applicable upon satisfaction of conditions communicated with said effective rate policy;
code for satisfying said conditions; and
code for receiving said data at said effective rate policy.
